(19) United States
(12) Patent Application Publication
(10) Pub. No.: US 2010/0133059 A1
(43) Pub. Date: Jun. 3, 2010

(54) Dual Electromagnetic Clutch Assembly

(76) Inventors: Fritz WINKLER, Toronto (CA); Ryszard Ostrowski, Mississauga (CA); Zoran Ivovic, Woodbridge (CA)

Correspondence Address: MAGNA INTERNATIONAL, INC., 337 MAGNA DRIVE, AURORA, ON, L4G-7K1, CA

(21) Appl. No.: 12/622,632

(22) Filed: Nov. 20, 2009

Related U.S. Application Data
(60) Provisional application No. 61/116,782, filed on Nov. 21, 2008.

(51) Int. Cl. F16D 27/06

(52) U.S. Cl. 192/84.21

(57) ABSTRACT

A dual clutch assembly is operable to drivingly couple a first shaft with one or both of second and third shafts. The clutch assembly has a coil housing having a first electromagnetic coil and a second electromagnetic coil. The first shaft is rotatably mounted to the coil housing. The first shaft is fixed for rotation with a first rotor cooperating with the first electromagnetic coil and a second rotor cooperating with the second electromagnetic coil. A first armature plate is elastically coupled to the second shaft to selectively couple and uncouple the first shaft with the second shaft upon energizing and de-energizing the first electromagnetic coil. A second armature plate is elastically coupled to a third shaft to selectively couple and uncouple the first shaft with the third shaft upon energizing and de-energizing the second electromagnetic coil.

### CROSS-REFERENCE TO RELATED APPLICATIONS

This application claims the benefit of U.S. Provisional Application No. 61/116,782, filed on Nov. 21, 2008. The entire disclosure of the above application is incorporated herein by reference.

### FIELD

The present invention generally relates to clutches. More specifically, embodiments of the present invention are concerned with a dual electromagnetic clutch assembly for multi-source rotatable inputs.

### BACKGROUND

Electromagnetic clutches are well known in the art and have been utilized commercially in many applications, including automobiles, for a number of years.

A typical electromagnetic clutch includes a rotor which generally comprises an inner annular bearing portion, a clutch portion extending generally radially outwardly from one end of the inner portion, and an outer annular portion extending from the clutch portion in a generally overlying spaced relation with respect to the inner portion. The spacing between the inner and outer annular portions receives an electromagnetic coil to be energized to create a flux field in the rotor which allows attracting an armature plate mounted to the outer annular portion for selective coupling therewith when the electromagnetic coil is energized.

The clutch portion often includes a series of arcuate slots which are operatively completed by and cooperates with arcuate slots in the armature plates. The purpose of the arcuate slots is to direct the flux field back and forth between the armature plate and the clutch portion of the rotor for efficient magnetic attraction between the armature plate and the rotor.

Such a clutch allows selectively coupling and uncoupling of a first rotatable shaft mounted, for example, to the rotor and a second rotatable shaft mounted, for example, to the armature plate.

### DRAWINGS

In the appended drawings:

FIG. 1 is a cross section of a dual electromagnetic clutch assembly according to an illustrative embodiment of the present invention; the clutch being shown in its neutral configuration;

FIG. 2 is a cross section of the dual electromagnetic clutch assembly from FIG. 1, illustrating the clutch in a first engaging configuration; and

FIG. 3 is a cross section of the dual electromagnetic clutch assembly from FIG. 1, illustrating the clutch in a second engaging configuration.

### DETAILED DESCRIPTION

Generally stated, illustrative embodiments of the present invention concern a dual electromagnetic clutch assembly for selective engagement of two or more rotatable elements such as, without limitations, shafts or hubs or a combination thereof.

A dual electromagnetic clutch assembly generally comprises an actuating mechanism including a first actuating element for receiving a first rotatable element, a second actuating element for receiving a second rotatable element. The clutch has a first neutral configuration, wherein the first actuating element is in a first neutral position relative to the second actuating element resulting in the first and second rotatable elements being disengaged, and a first engaging configuration wherein the first actuating element is coupled to the second actuating element, resulting in the first and second rotatable elements being engaged.

A coupler is mounted to each of the first and second actuating elements of the actuating mechanism. Each coupler is provided i) for interconnecting the rotatable element and the respective actuating element of the actuating mechanism, ii) for biasing the actuating element towards the neutral position when the actuating mechanism is moved from the engaging configuration to the neutral configuration, and iii) for damping oscillations to and from the rotatable element when the actuating mechanism is in the engaging configuration.

A dual electromagnetic clutch includes a central plate with first and second coils fixed to the central plate. A first shaft is supported for rotation relative to the central plate. A second shaft is supported for rotation relative to the first shaft. A third shaft is supported for rotation relative to the first shaft. A first armature plate is coupled to the second shaft via a first elastomeric member. A second armature plate is coupled to the third shaft via a second elastomeric member. First and second rotors are positioned on opposite sides of the central plate and fixed for rotation with the first shaft. The first rotor is positioned between the first coil and the first armature plate. The second rotor is positioned between the second coil and the second armature plate. Energization of the first coil drivingly couples the first armature plate and the first rotor and energization of the second coil drivingly couples the second armature plate and the second rotor.

The present disclosure also provides an electromagnetic clutch assembly including a coil housing having a first electromagnetic coil and a second electromagnetic coil. A shaft is rotatably mounted to the coil housing. The shaft includes a first rotor cooperating with the first electromagnetic coil and a second rotor cooperating with the second electromagnetic coil. First and second hubs are rotatably mounted relative to the shaft. A first armature plate is elastically coupled to the first hub and is moveable relative to the first rotor to selectively couple and uncouple the first rotor with the first hub upon energizing and de-energizing the first electromagnetic coil. A second armature plate is elastically coupled to the second hub and is moveable relative to the second rotor to selectively couple and uncouple the second rotor with the second hub upon energizing and de-energizing the second electromagnetic coil.

In the following description, similar features in the drawings have been given similar reference numerals, and in order not to weigh down the figures, some elements are not referred to in some figures if they were already identified in a precedent figure.

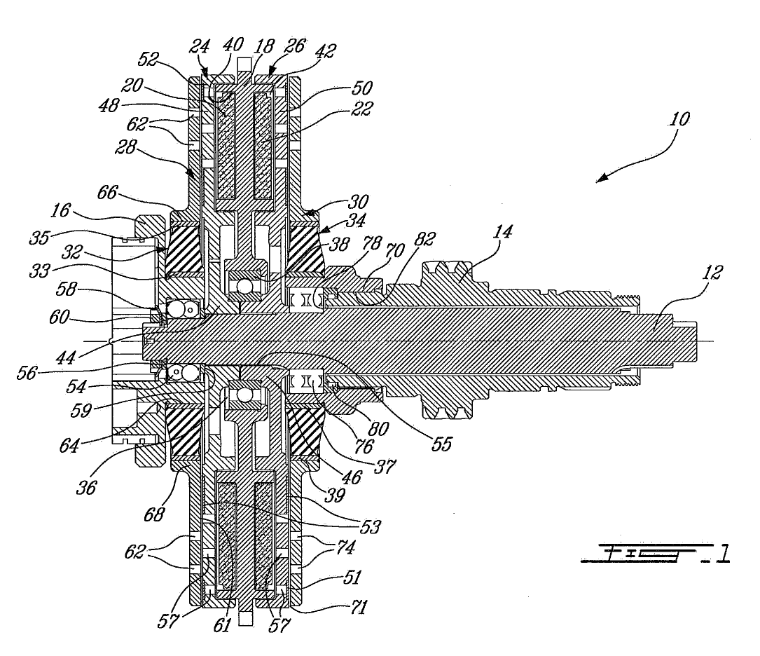

Turning now to FIG. 1 of the appended drawings, a dual electromagnetic clutch assembly 10 for selectively coupling three rotatable elements 12, 14 and 16 according to an illustrative embodiment of the present invention will be described.

According to the first illustrative embodiment, the clutch allows torque transmission allowing various coupling arrangements between the shaft 12, the shaft 14, coaxially mounted to the shaft 12, and the hub 16, also coaxially mounted to the shaft 12 adjacent the end thereof.

As will become more apparent upon reading the following description, a clutch according to illustrative embodiments of the present invention is not limited to such an arrangement and/or application and can be used to generally couple one or more rotatable elements, such as, without limitations, rotatable shafts and hubs.

The dual electromagnetic clutch assembly 10 comprises a central plate or coil housing 18, which is configured to be fixedly mounted to a frame or structure (not shown) and which includes two sets of independent circumferentially extending coils 20 and 22 and two rotors 24 and 26. Rotors 24 and 26 are coaxially and mutually mounted to the shaft 12 for rotation therewith. Rotors 24 and 26 are mounted preferably on opposite sides of coil housing 18. The clutch assembly 10 further comprises two armature plates 28 and 30 connected respectively to the hub 16 via a coupler 32 and to the shaft 14 via a coupler 34.

The coil housing 18 is a disk-like body including a central aperture 36 for rotatably mounting the coil housing 18 to the rotors 24, 26 via a bearing 38 and having two outer coil-receiving annular recesses 40 and 42 on opposite sides of the coil housing 18, which respectively receives the set of electromagnetic coils 20 and 22. The bearing 38 is pressed in the aperture 36, rotatably mounting rotors 24 and 26 to the coil housing 18. Since this bearing 38 is staked within the coil housing 18 and sandwiched between rotors 24 and 26, its axial position is ensured.

Each coil 20 and 22 is independently wound and optionally contains a thermo-fuse and diode (both not shown), preventing damage to the power supply to which they are connected (not shown) in the case of clutch over-heating as well as from transitional currents during clutch disengagement.

The rotors 24 and 26 are snugly-fitted between the generator shaft 12 and the coil housing 18. For that purpose, the rotors 24 and 26 include respective hub portions 44 and 46 and coupling portions 48 and 50, radially extending from the hub portions 44 and 46, for coupling with a respective armature plate 28 and 30. The rotors 24 and 26 are further provided with outer friction liners 51 and inner friction liners 53. These liners 51 and 53, which are made of high friction material such as ceramics, silicates, etc. are provided to enhance torque transmission between the corresponding rotors 24 or 26 and armature plates 28 or 30 and decrease noise during the clutch part engagement.

The hub portions 44 and 46 are further configured for lock-engagement with a spline portion 55 of the generator shaft 12. The rotors 24 and 26 are therefore rotatable in unison with the generator shaft 12. The radial position of the rotors 24, 26 is ensured by a slide fit cylindrical abutment of the hub portions 44, 46 onto the shaft 12.

The coupling portions 50 and 52 are in the form of annular recesses configured for receiving a corresponding coil 20 and 22.

Each of the coupling portions 50 and 52 further includes arcuate slots 57, which allow conventionally channeling magnetic flux between the rotor 24 or 26 and the corresponding armature plate 28 or 30.

The hub 16 is supported by a pressed in and staked double row bearing 54 over the shaft 12. This bearing 54 is axially locked over shaft 12 using spacer 56, lock washer 58 and locknut 60. The same bearing 54 locks the rotor 24 and 26 sub-assembly axially using a spacing washer 59 and the bearing 38. Of course, another locking arrangement can be provided. The bearing 54 ensures the alignment of the hub 16 over the shaft 12 and its independent operation therefrom when the coil 20 is not energized.

The armature plate 28 is ring-shaped and is coaxially mounted to the hub 16 via the coupler 32 for rotation therewith so as to be parallel to the rotor 24 in close proximity therefrom so as to yield an air gap 61 therebetween and for operative coupling with the armature plate 28. Similarly to the rotor 24, and for the same purpose as described above, the portion of the plate 28 includes arcuate slots 62, which are positioned radially in specific relation to arcuate slots 57 on rotor 24, so as to maximize the magnetic force produced for a given current at a constant voltage. This further allows maximizing the coupling between the armature 28 and the rotor 24 when the coil 20 is energized.

The coupler 32 is an elastomeric annular-shaped spring sandwiched between an inner ring 33 and an outer ring 35 and having a decreasing section from the inner ring 33 to the outer ring 35. The inner ring 33 is mounted to a shoulder 64 of the hub 16, while the outer ring 35 is mounted to an opening 66 of the armature plate 28. The opening of the armature plate 28 includes a collar 68 onto which the outer ring 35 of the spring 32 abuts. The annular spring 32 is secured between the armature plate 28 and the hub 16 by friction interference fit.

The elastomeric spring 32 is drivingly secured to both the hub 16 and to armature plate 28 preferably with fasteners and/or adhesive.

The elastomeric spring 32 allows the armature plate 28 to move axially and engage the rotor 24 when the coil 20 is energized. The increased magnetic force caused by the coil 20, inversely proportional to the thickness of the air gap 61, establishes contact generating friction between the armature plate 28 and the rotor 24 through their metal surfaces as well as through friction liners 51 and 53.

The elastomeric spring 32 biases the armature plate 28 to urge the armature plate 28 away from the rotor 24 thereby ensuring disengagement of the armature plate 28 from the rotor 24 after the coil 20 deactivation.

The configuration and/or density of the spring 32 yield an optimized elastomeric spring rate which allows the magnetic flux forces from the coil 20 to close the gap 61 when the coil 20 is energized, and causes the spring biasing force to be sufficient to reinstate the gap 61 once the coil 20 is deactivated.

Another function of the annular elastomeric spring 32 is to provide dynamic isolation and damping of the torsional vibrations. This damping provides a beneficial effect on multiple transmission components: transfer case, generator, electric motor, etc.

Similar to the armature plate 28, the armature plate 30 is ring-shaped and is coaxially mounted to shaft 14 via the hub 70 and coupler 34 so as to be parallel to the rotor 26 in close proximity therefrom so as to yield an air gap 71 therebetween and for operative coupling of the armature plate 30 with the rotor 26.

Also similar to the plate 28, and for the same purpose, the armature plate 30 includes arcuate slots 74.

The elastomeric spring 34, which is preferably identical to the spring 32, is mounted between the armature plate 30 (via its outer ring 39) and the shaft 14 for their interconnection via a hub 70 on the shaft side. More specifically, the inner ring 37 of the spring 34 is mounted to a shoulder of the hub 70. The hub 70 is radially supported by a double bearing 76. Bearing 76 is staked in the hub 70. The inner annulus of the bearing 76 is sandwiched between the rotor assembly 26 and a shoulder 78 on the generator shaft 12. The bearing 76 ensures the alignment of the hub 70 over the shaft 12 and its independent operation therefrom when the coil 22 is not energized.

The hub 70 also houses an oil seal 80. A splined joint 82 allows locking the hub 70 onto the shaft 14 to allow rotation in unison.

The couplers 32 and 34 are made preferably of natural or synthetic rubber material. However the couplers can be made of any elastomer such as EPDM, silicone rubber, etc. The couplers according to embodiments of the present invention are however not limited to the above illustrated embodiments. They can be made of any other suitable resilient material, and their configuration and size may differ to those illustrated.

The elastomeric springs 32 and 34 are either molded between their respective armature plates 28 and 30 and hubs 16 and 70 or molded between two rings (such as 33 and 35, or 37 and 39) that are pressed into the armature plate 28 or 30 and hub 16 or 70 respectively, ensuring sufficient axial stiffness to separate the armature plate from the rotor when the coil is deactivated as well as providing torsional oscillation damping while the coil is activated and the clutch engaged.

The coils 20 and 22 are connected to a conventional or to a custom control system (not shown) which regulates their operation.

The first and second armature plates 28 and 30 respectively define first and third actuating elements. The coil housing 18 with the first and second coils 20 and 22 together with the first and second rotors 24 and 26 define what will be referred to as the second actuating element.

The clutch assembly 10 can then be seen as having two actuating mechanisms: the first one being defined by the interaction of the first and second actuating elements and the second by the interaction of the second and third actuating elements.

The first actuating mechanism has a first neutral configuration, wherein the first actuating element is in a first neutral position relative to the second actuating element and a first engaging configuration wherein the first actuating element is coupled to the second actuating element.

Similarly, the second actuating mechanism has a second neutral configuration, wherein the third actuating element is in a second neutral position relative to the second actuating element and a second engaging configuration wherein the third actuating element is coupled to the second actuating element.

Considering the above, a person skilled in the art will now appreciate that a dual acting clutch according to illustrative embodiments of the present invention is not limited to having two actuating mechanisms. For example, a clutch according to a further illustrative embodiment can include a single actuating mechanism. For example, using, as a reference the example of an electromagnetic clutch similar to the clutch assembly 10, such a single electromagnetic clutch (not shown) would include a single coil, a single rotor secured to a first shaft, and a single armature plate secured to a second shaft for selective coupling to the first shaft, the armature plate being interconnected to the second shaft via a coupler providing the functionalities of the couplers 32 and 34.

Returning to the clutch assembly 10, its operation will now be described in further detail with reference to FIGS. 1 to 3.

In operation, when neither of the coils 20, 22 are energized, the air gap 61 on the generator side as well as the air gap 71 ensure that no torque is carried through the clutch assembly 10. The first and second actuating mechanisms are in their neutral configuration as is illustrated in FIG. 1.

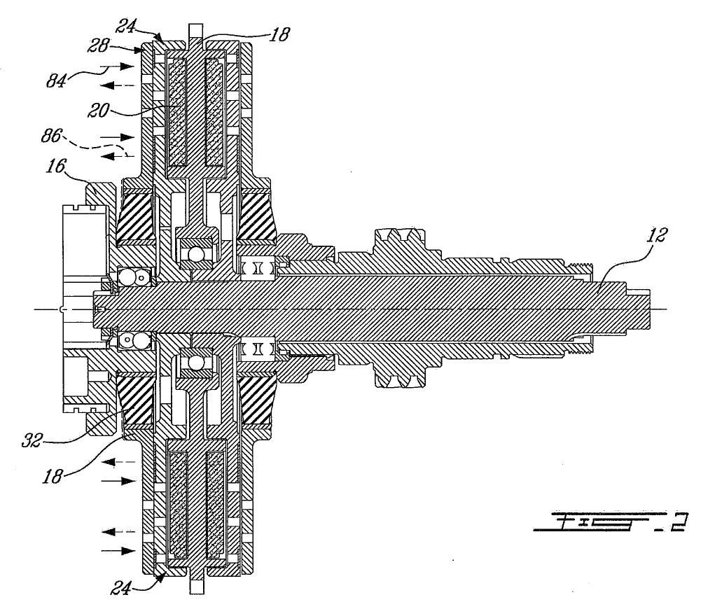

With reference now to FIG. 2, once coil 20 is energized, the first actuating mechanism is moved from its neutral configuration of FIG. 1 to its first engaging configuration by the magnetic flux floating through coil housing 18 and rotor 24, resulting in rotor 24 attracting the corresponding armature plate 28 (see arrows 84) so as to close the gap 61 (see FIG. 1). A torque transmittal contact is thus generated between the shaft 12 and the hub 16, effectively connecting through the damped torsional joint, which is then slightly deformed to allow the closing of the gap 61. As mentioned hereinabove, the coupler 32 then reduces the amount of torsional vibration transmitted through the clutch.

When the coil 20 is de-energized, the armature plate 24 element is biased towards its first neutral position (shown in FIG. 1) by the biasing force of the spring 32 (see arrows 86) resulting in the first actuating mechanism being moved from the first engaging configuration to the first neutral configuration.

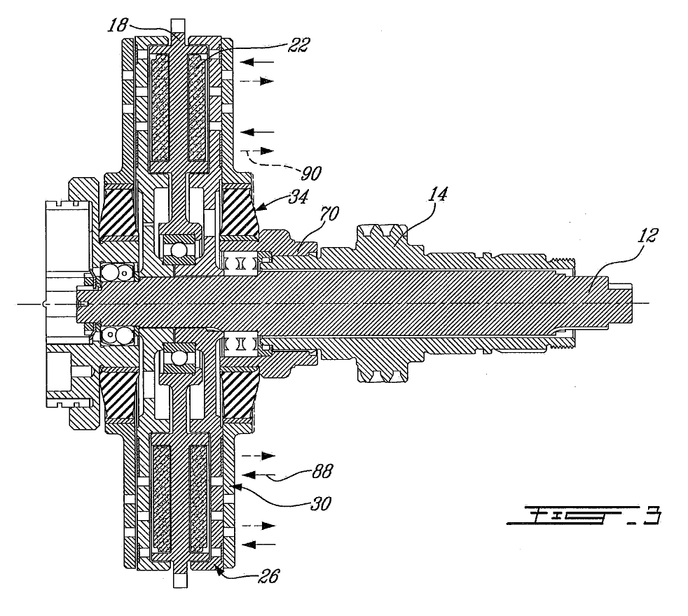

With reference now to FIG. 3, once the coil 22 is energized, the second actuating mechanism is moved from its neutral configuration of FIG. 1 to its second engaging configuration by the magnetic flux floating through coil housing 18 and rotor 26, resulting in rotor 26 attracting the corresponding armature plate 30 (see arrows 88) so as to close the gap 71 (FIG. 1). An interconnection is initiated between the shafts 12 and 14, through the damped torsional joint, which is then slightly deformed to allow the closing of the gap 71. The coupler 34 also reduces the amount of torsional vibration that is transferred through the clutch assembly 10.

When the coil 22 is de-energized, the armature plate 30 is biased towards its second neutral position by the biasing force of the spring 34 (see arrows 90) resulting in the second actuating mechanism being moved from the second engaging configuration to the second neutral configuration.

If both coils 20 and 22 are energized, a magnetic flux is generated through coil housing 18 and both rotors 24 and 26. The resulting magnetic force closes respective air gaps 61 and 71, creating torsional coupling between rotor 24 and armature plate 28 as well as between rotor 26 and armature plate 30, through respective coupler 32 and 34 as described hereinabove. Both actuating mechanisms are then moved from their neutral configuration to their engaging configuration as described hereinabove. In this configuration, torque is provided to both outputs.

It is to be noted that both actuating mechanisms act independently.

It is to be noted that depending on the elements mounted to the shafts 12, 14 and to the hub 16, it may be desirable to follow a particular sequence of engagement and disengagement of the actuating mechanism to minimize unwanted effects.

A clutch according to embodiments of the present invention is not limited to include coil-based actuating mechanism or any other electromechanical actuating mechanism. The one or more actuating mechanism can be, for example, purely mechanical.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the scope of the subject invention as defined in the appended claims.

What is claimed is:

1. A dual electromagnetic clutch comprising:
a central plate;
first and second coils fixed to the central plate;
a first shaft supported for rotation relative to the central plate;
a second shaft supported for rotation relative to the first shaft;
a third shaft supported for rotation relative to the first shaft;
a first armature plate coupled to the second shaft via a first elastomeric member;
a second armature plate coupled to the third shaft via a second elastomeric member;
first and second rotors being positioned on opposite sides of the central plate and fixed for rotation with the first shaft, the first rotor being positioned between the first coil and the first armature plate, the second rotor being positioned between the second coil and the second armature plate, wherein energization of the first coil drivingly couples the first armature plate and the first rotor and energization of the second coil drivingly couples the second armature plate and the second rotor.

2. The dual electromagnetic clutch of claim 1 wherein the first elastomeric member is shaped as a ring radially positioned between the first armature plate and the second shaft.

3. The dual electromagnetic clutch of claim 1 wherein the second and third shafts are, coaxially mounted for rotation on the first shaft.

4. The dual electromagnetic clutch of claim 1 wherein the first and second coils are positioned within annular recesses formed on opposite sides of the central plate.

5. The dual electromagnetic clutch of 4 wherein the first and second coils are circumferentially wound about the shaft axis of rotation.

6. The dual electromagnetic clutch of claim 5 wherein the first and second coils are axially positioned between the first and second rotors.

7. The dual electromagnetic clutch of claim 6 wherein the first and second rotors are axially positioned between the first and second armature plates.

8. The dual electromagnetic clutch of claim 1 wherein the first elastomeric member allows axial translation and rotation of the first armature plate relative to the first rotor.

9. The dual electromagnetic clutch of claim 1 further including a bearing positioned within a bore formed in the central plate supporting both of the first and second rotors.

10. The dual electromagnetic clutch of claim 1 wherein the first elastomeric member has a varying thickness with a radially inward portion having a greater thickness than a radially outward portion.

11. The dual electromagnetic clutch of claim 1 wherein the first and second rotors include arcuate slots extending therethrough.

12. The dual electromagnetic clutch of claim 1 wherein each of the first and second rotors overlap the central plate.

13. The dual electromagnetic clutch of claim 1 wherein the central plate forms a portion of a housing being restricted from rotation.

14. The dual electromagnetic clutch of claim 1 wherein the central plate is substantially symmetrically shaped.

15. The dual electromagnetic clutch of claim 1 wherein the first and second coils are individually energizable.

16. A dual electromagnetic clutch assembly comprising:
a coil housing having a first electromagnetic coil and a second electromagnetic coil;
a shaft rotatably mounted to the coil housing, the shaft having a first rotor cooperating with the first electromagnetic coil and a second rotor cooperating with the second electromagnetic coil;
a first hub rotatably mounted relative to the shaft;
a second hub rotatably mounted relative to the shaft;
a first armature plate elastically coupled to the first hub, the first armature plate being moveable relative to the first rotor to selectively couple and uncouple the first rotor with the first hub upon energizing and de-energizing the first electromagnetic coil; and
a second armature plate elastically coupled to the second hub, the second armature plate being moveable relative to the second rotor to selectively couple and uncouple the second rotor with the second hub upon energizing and de-energizing the second electromagnetic coil.

17. The dual electromagnetic clutch assembly of claim 16, wherein the first armature plate is elastically coupled to the first hub by a first elastomeric ring and the second armature plate is elastically coupled to the second hub by a second elastomeric ring.

18. The dual electromagnetic clutch assembly of claim 17, wherein the first hub and the second hub are co-axially mounted for rotation on the shaft.

19. The dual electromagnetic clutch assembly of claim 16 wherein the first and second coils are axially positioned between the first and second rotors.

20. The dual electromagnetic clutch assembly of claim 19 wherein the first and second rotors are axially positioned between the first and second armature plates.
